(19) United States
(12) Patent Application Publication
(10) Pub. No.: US 2007/0169525 A1
(43) Pub. Date: Jul. 26, 2007

(54) Electric door lock

(75) Inventor: Jing-Chen Chang, Tou-Liu City (TW)

Correspondence Address: MCNEES WALLACE & NURICK LLC, 100 PINE STREET, P.O. BOX 1166, HARRISBURG, PA, 17108-1166, US

(73) Assignee: EZ TREND TECHNOLOGY CO., LTD., Ming-Hsiung Township (TW)

(21) Appl. No.: 11/336,373

(22) Filed: Jan. 20, 2006

(51) Int. Cl. E05B 55/04

(52) U.S. Cl. 70/472

(57) ABSTRACT

An electric door lock includes a latching unit, and first and second rotatable members. The latching unit is movable between latching and unlatching positions. The first rotatable member is provided with a first protrusion, and is rotatable between first and second angular positions corresponding to the latching and unlatching positions of the latching unit. The second rotatable member is provided with a second protrusion, and is rotatable in a first rotational direction such that the second protrusion pushes the first protrusion so as to move the first rotatable member from the first angular position to the second angular position, and in a second rotational direction such that the second protrusion pushes the first protrusion so as to move the first rotatable member from the second angular position back to the first angular position.

### BACKGROUND OF THE INVENTION

1. Field of the Invention

This invention relates to a door lock, more particularly to an electric door lock.

2. Description of the Related Art

In U.S. Patent Application Publication No. 2004/0245785, there is disclosed a conventional electric door lock that includes a lock housing, a latching member, a manual operating member, first and second rotatable members, and an electric driving unit. The latching member is movable between latching and unlatching positions. The manual operating member extends rotatably into the lock housing, is coupled to the latching member, and is operable so as to move the latching member between the latching and unlatching positions. The first rotatable member is in the form of a sector gear, and is mounted rotatably in the lock housing. The second rotatable member is in the form of a gear, is mounted rotatably in the lock housing, and is coupled to the latching member. The second rotatable member is rotatable relative to the lock housing from a first angular position, where the latching member is disposed at the latching position, to a second angular position, where the latching member is disposed at the unlatching position. The electric driving unit includes a motor that is operable so as to drive rotation of the first rotatable member.

In operation, at an initial position, in which the latching member is at the latching position, activation of the motor of the electric driving unit results in clockwise rotation of the first rotatable member, eventual engagement between the first and second rotatable members, counter-clockwise rotation of the second rotatable member to the second angular position, thereby moving the latching member to the unlatching position, and eventual disengagement between the first and second rotatable members. At this time, reactivation of the motor of the electric driving unit results in counter-clockwise rotation of the first rotatable member, eventual engagement between the first and second rotatable members, clockwise rotation of the second rotatable member to the first angular position, thereby moving the latching member back to the latching position, and eventual disengagement between the first and second rotatable members.

The conventional electric door lock further includes first and second switches, each of which deactivates the motor of the electric driving unit when actuated. The first switch is actuated when the second rotatable member is rotated to the first angular position. The second switch is actuated when the second rotatable member is rotated to the second angular position.

The aforesaid conventional electric door lock is disadvantageous in that, since each of gear teeth of each of the first and second rotatable members has a certain degree of thickness, proper engagement between the first and second rotatable members cannot be ensured during operation of the conventional electric door lock. Moreover, the aforesaid conventional electric door lock includes numerous switches.

### SUMMARY OF THE INVENTION

Therefore, the object of the present invention is to provide an electric door lock that can overcome the aforesaid drawbacks of the prior art.

According to the present invention, an electric door lock comprises an internal lock housing, a latching unit, a manual operating member, first and second rotatable members, and an electric driving unit. The internal lock housing is formed with a handle mounting hole, and defines an accommodating space. The latching unit is movable between latching and unlatching positions. The manual operating member is mounted rotatably on the internal lock housing, extends into the accommodating space through the handle mounting hole, and is coupled to the latching unit. The manual operating member is rotatable relative to the internal lock housing between a first angular position so as to dispose the latching unit at the latching position, and a second angular position so as to dispose the latching unit at the unlatching position. The first rotatable member is disposed in the accommodating space in the internal lock housing, is coupled to the manual operating member so as to be co-rotatable therewith between the first and second angular positions, and is provided with a first protrusion. The second rotatable member is disposed in the accommodating space in the internal lock housing, is mounted rotatably on the internal lock housing, and is provided with a second protrusion. The second rotatable member is rotatable relative to the internal lock housing in a first rotational direction such that the second protrusion pushes the first protrusion so as to move the first rotatable member from the first angular position to the second angular position, and in a second rotational direction opposite to the first rotational direction such that the second protrusion pushes the first protrusion so as to move the first rotatable member from the second angular position back to the first angular position. The electric driving unit is mounted in the accommodating space in the internal lock housing and is operable so as to drive rotation of the second rotatable member.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an electric door lock according to the present invention;

FIG. 2 is a fragmentary exploded perspective view to illustrate first and second rotatable members of the preferred embodiment;

FIGS. 3 to 5 are schematic views to illustrate operation of the preferred embodiment in an automated mode for moving a latching unit of the preferred embodiment from an unlatching position to a latching position; and

FIG. 6 is a schematic view to illustrate engagement between first and second protrusions of the preferred embodiment during operation of the preferred embodiment in the automated mode for moving the latching unit from the latching position back to the unlatching position.

### DETAILED DESCRIPTION OF THE PREFERRED EMBODIMENT

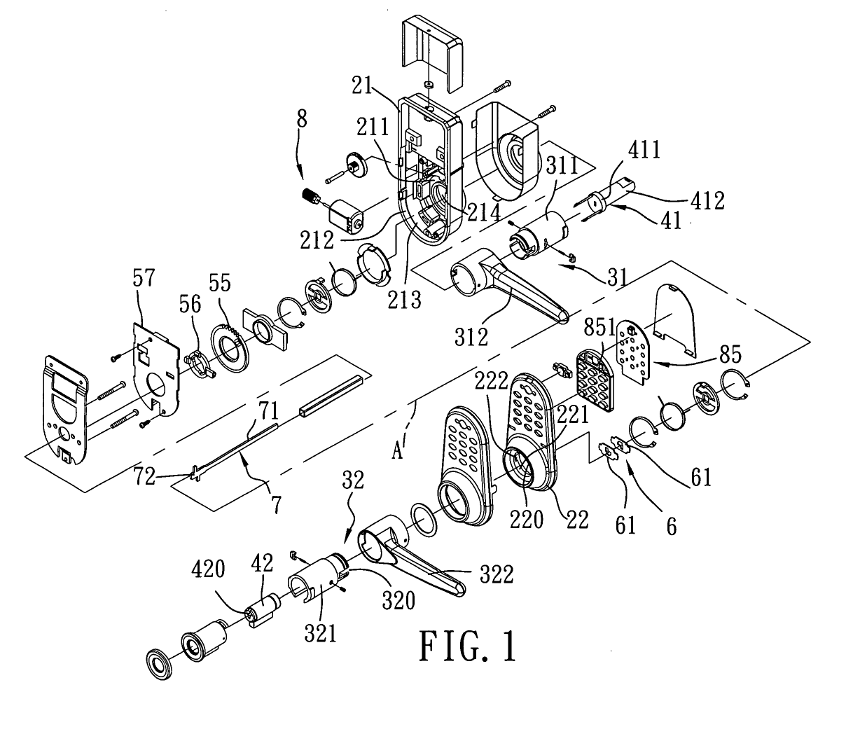

Referring to FIG. 1, the preferred embodiment of an electric door lock according to the present invention is shown to include an internal lock housing 21, a latching unit 6, a manual operating member 41, first and second rotatable members 56, 55, and an electric driving unit.

The electric door lock of this embodiment is mounted on a door panel (not shown) that has opposite first and second surfaces (not shown), and is operable both in manual and automated modes, in a manner that will be described hereinafter.

The internal lock housing 21 is mounted on the first surface of the door panel, and has a base wall 211, and a surrounding wall 212 that extends from a periphery of the base wall 211 of the internal lock housing 21 and that cooperates with the base wall 211 of the internal lock housing 21 to define an accommodating space 213. The base wall 211 of the internal lock housing 21 is formed with a first mounting hole 214 that is in spatial communication with the accommodating space 213 in the internal lock housing 21 and that has a hole axis (A).

The electric door lock further includes an external lock housing 22 that is mounted on the second surface of the door panel. In this embodiment, the external lock housing 22 is formed with a second mounting hole 220 that is coaxial with the first mounting hole 214.

The electric door lock further includes internal and external handle units 31, 32. The internal handle unit 31 is mounted rotatably on the internal lock housing 21, and is operable so as to rotate relative to the internal lock housing 21. In this embodiment, the internal handle unit 31 includes a hollow cylindrical part 311 that extends rotatably into the accommodating space 213 in the internal lock housing 21 through the first mounting hole 214 in the base wall 211 of the internal lock housing 21, and a handle 312 that is connected to the cylindrical part 311 of the internal handle unit 31. The external handle unit 32 is mounted rotatably on the external lock housing 22, and is operable so as to rotate relative to the external lock housing 22. In this embodiment, the external handle unit 32 includes a hollow cylindrical part 321 that extends into the external lock housing 22 through the second mounting hole 220 in the external lock housing 32, and a handle 322 that is connected to the cylindrical part 321 of the external handle unit 32.

The latching unit 6 is disposed movably in the second mounting hole 220 in the external lock housing 22, and is movable relative to the external lock housing 22 between latching and unlatching positions. In particular, the latching unit 6 includes a pair of latching members 61. The second mounting hole 220 in the external lock housing 22 is defined by a hole-defining wall 221 that is formed with diametrically disposed engaging grooves 222. The cylindrical part 321 of the external handle unit 32 is formed with diametrically opposite engaging holes 320. When the latching unit 6 is at the latching position, each of the latching members 61 of the latching unit 6 projects radially and outwardly with respect to the hole axis (A) to thereby engage a respective one of the engaging holes 320 in the cylindrical part 321 of the external handle unit 32 and a respective one of the engaging grooves 222 in the hole-defining wall 221 of the external lock housing 22. At this time, the external handle unit 32 is inoperable. On the other hand, when the latching unit 6 is at the unlatching position, each of the latching members 61 of the latching unit 6 retracts radially and inwardly with respect to the hole axis (A) to thereby disengage the respective one of the engaging holes 320 in the cylindrical part 321 of the external handle unit 32 and the respective one of the engaging grooves 222 in the hole-defining wall 221 of the external lock housing 22. At this time, the external handle unit 32 is operable.

It is noted that the internal handle unit 31 is operable regardless of the position of the latching members 61 of the latching unit 6.

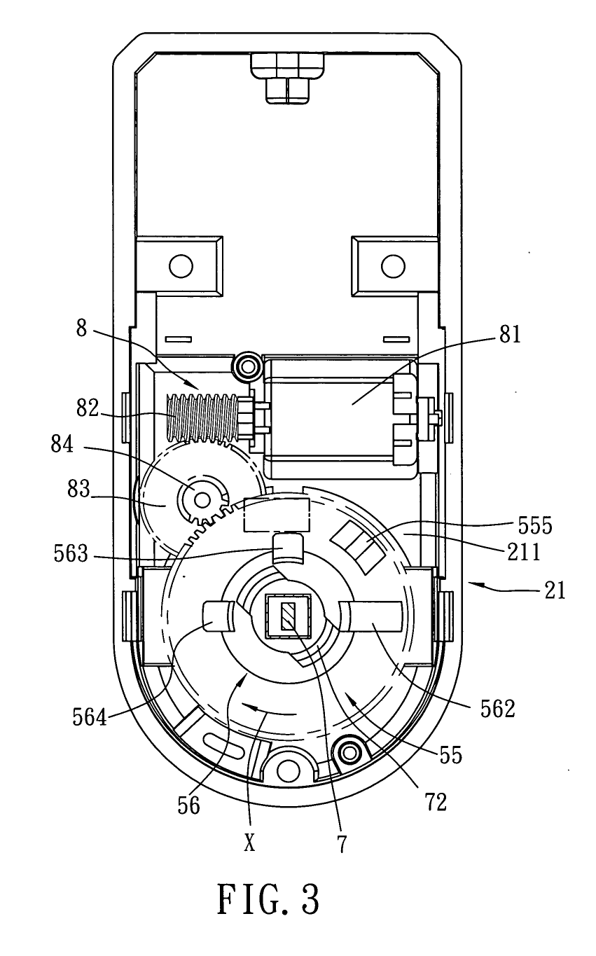

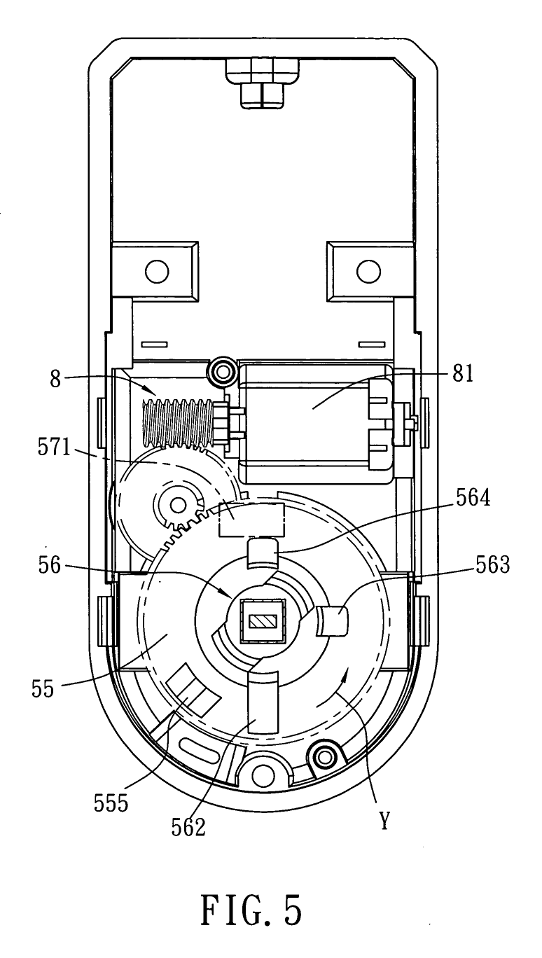

The electric door lock further includes an operating rod member 7 that extends through the latching members 61 of the latching unit 6 and that has opposite first and second ends 71, 72. In this embodiment, the operating rod member 7 is rotatable relative to the internal and external lock housings 21, 22 between a first angular position so as to dispose the latching unit 6 at the latching position (see FIG. 5), and a second angular position so as to dispose the latching unit 6 at the unlatching position (see FIG. 3).

It is noted that, in this embodiment, the first and second angular positions are angularly displaced by an angle of 90 degrees.

The manual operating member 41 is mounted rotatably on the internal lock housing 21, and has a first end portion 412 that is disposed externally of the internal lock housing 21, and a second end portion 411 that extends into the accommodating space 213 in the internal lock housing 21 through the cylindrical part 311 of the internal handle unit 31, and that is connected to the first end 71 of the operating rod member 7 so as to be co-rotatable therewith between the first and second angular positions.

The electric door lock further includes a lock member 42 that is disposed in the cylindrical part 321 of the external handle unit 32, that extends into the external lock housing 22, and that is coupled to the second end 72 of the operating rod member 7. In this embodiment, the lock member 42 is operable so as to rotate the operating rod member 7 between the first and second angular positions.

It is noted that the lock member 42 is operable with the use of a key (not shown) that is inserted into a keyhole 420 thereof.

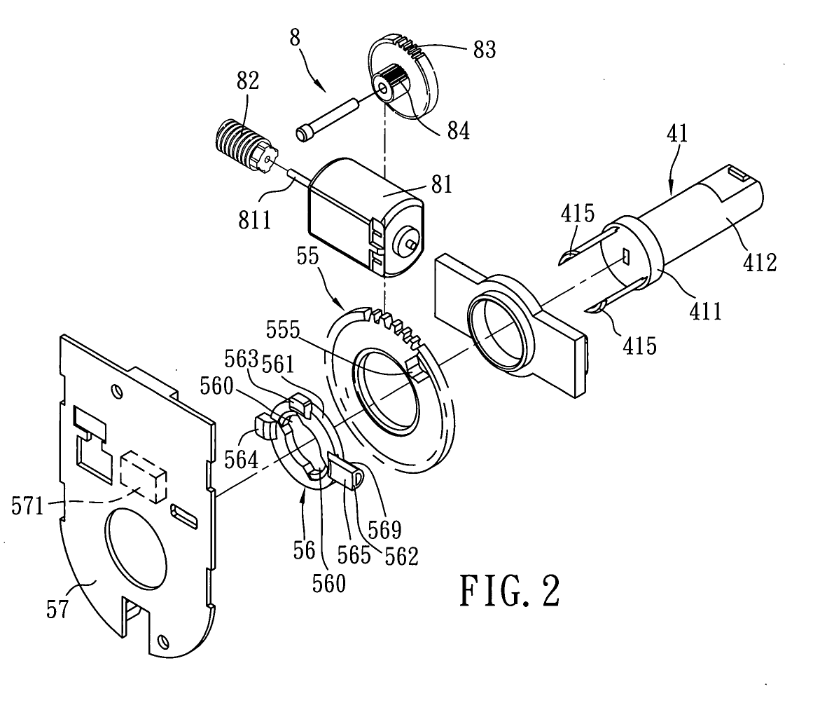

With further reference to FIG. 2, the first rotatable member 56 includes a ring portion 561 that is sleeved securely on the second end portion 411 of the manual operating member 41 so as to be co-rotatable therewith between the first and second angular positions. In particular, the ring portion 561 of the first rotatable member 56 is formed with a pair of diametrically disposed engaging recesses 560. The second end portion 411 of the manual operating member 41 is provided with a pair of axially extending arms 415, each of which engages a respective one of the engaging recesses 560 in the ring portion 561 of the first rotatable member 56. In this embodiment, the first rotatable member 56 is provided with a first protrusion 562 that extends radially and outwardly from the ring portion 561 of the first rotatable member 56, that is semi-circular in cross-section, that is made from a resilient material, and that has flat and round portions 565, 569.

The second rotatable member 55 is disposed in the accommodating space 213 in the internal lock housing 21, is co-axially disposed around the second end portion 411 of the manual operating member 41, and is mounted rotatably on the base wall 211 of the internal lock housing 21. In this embodiment, the second rotatable member 55 is in the form of a gear that is provided with a second protrusion 555 protruding axially toward the first rotatable member 56. In this embodiment, the second protrusion 555 has a trapezoidal shape. The second rotatable member 55 is rotatable relative to the internal lock housing 21 in a first rotational direction such that the second protrusion 555 pushes the first protrusion 562 so as to move the first rotatable member 56 from the first angular position to the second angular position, and in a second rotational direction opposite to the first rotational direction such that the second protrusion 555 pushes the first protrusion 562 so as to move the first rotatable member 561 from the second angular position back to the first angular position.

The electric driving unit 8 is mounted in the accommodating space 213 in the internal lock housing 21, and is operable so as to drive rotation of the second rotatable member 55 in the first and second rotational directions. In particular, the electric driving unit 8 includes a motor 81 that has a transmission shaft 811, a worm gear 82 that is sleeved fixedly on the transmission shaft 811 of the motor 81, a first gear 83 that is mounted rotatably on the base wall 211 of the internal lock housing 21 and that meshes with the worm gear 82, and a second gear 84 that is connected to and that co-rotates with the first gear 83, and that meshes with the second rotatable member 55. In this embodiment, the electric driving unit 8 may be operated using a remote controller (not shown), or a keypad 851 of a user input unit 85 (see FIG. 1) that is mounted on the external lock housing 22.

The electric door lock further includes a switching unit for deactivating the motor 81 of the electric driving unit 8 when the first rotatable member 56 has been moved from one of the first and second angular positions to the other of the first and second angular positions. In particular, the switching unit includes a sensing element 571, such as a micro-switch, and a pair of first and second actuators 563, 564. The sensing element 571 of the switching unit is disposed in the external lock housing 22, is mounted on a printed circuit board 57, is coupled electrically to the motor 81 through the printed circuit board 57, and is operable so as to deactivate the motor 81 of the electric driving unit 8 when actuated. The first actuator 563 of the switching unit is provided on the first rotatable member 56, and is angularly displaced from the first protrusion 562 by an angle of 90 degrees. The second actuator 564 of the switching unit is provided on the first rotatable member 56, and is angularly displaced from the first actuator 563 by an angle of 90 degrees and from the first protrusion 562 by an angle of 180 degrees.

In operation, at an initial position, in which the latching unit 6 is at the unlatching position, operation of the external handle unit 32 is enabled. At this time, when it is desired to operate the electric door lock of this invention in the manual mode using the manual operating member 41 to disable operation of the external handle unit 32, the manual operating member 41 is rotated from the second angular position to the first angular position. This results in rotation of the operating rod member 7 from the second angular position (see FIG. 3) to the first angular position (see FIG. 5), and movement of the latching unit 6 from the unlatching position to the latching position, thereby disabling operation of the external handle unit 32. At this time, when it is desired to operate the electric door lock of this invention in the manual mode using the manual operating member 41 to enable operation of the external handle unit 32, the manual operating member 41 is rotated from the first angular position back to the second angular position. This results in rotation of the operating rod member 7 from the first angular position back to the second angular position, and movement of the latching unit 6 from the latching position to the unlatching position, thereby enabling operation of the external handle unit 32.

In addition, at the initial position, when it is desired to operate the electric door lock of this invention in the manual mode using the lock member 42 to disable operation of the external handle unit 32, the lock member 42 is operated with the use of the key to rotate the operating rod member 7 from the second angular position to the first angular position. This results in movement of the latching unit 6 from the unlatching position to the latching position, thereby disabling operation of the external handle unit 32. At this time, when it is desired to operate the electric door lock of this invention in the manual mode using the lock member 42 to enable operation of the external handle unit 32, the lock member 42 is operated with the use of the key to rotate the operating rod member 7 from the first angular position to the second angular position. This results in movement of the latching unit 6 from the latching position to the unlatching position, thereby enabling operation of the external handle unit 32.

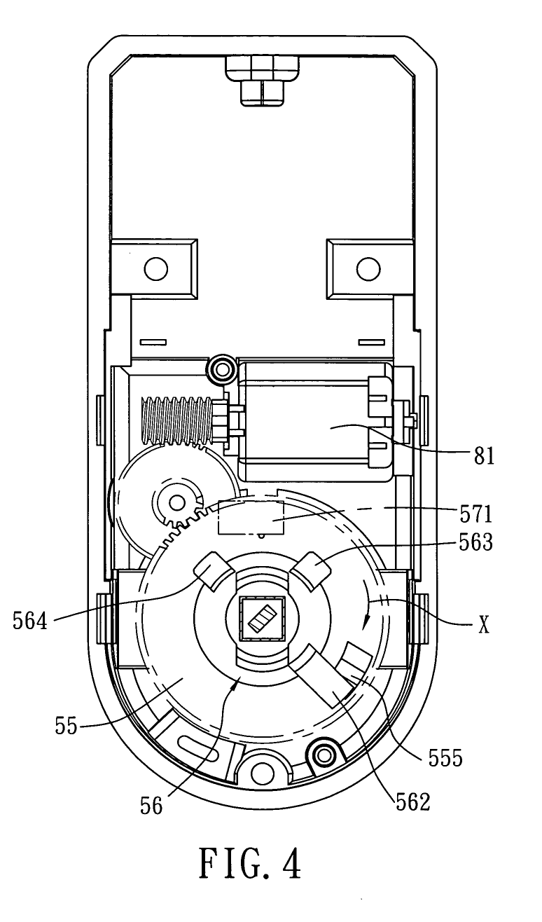

Moreover, at the initial position, when it is desired to operate the electric door lock of this invention in the automated mode to disable operation of the external handle unit 32, referring to FIG. 3, the motor 81 of the electric driving unit 8 is activated with the use of the remote controller (not shown) or the keypad 851 of the user input unit 85 (see FIG. 1). This results in rotation of the second rotatable member 55 in the second rotational direction, as indicated by the arrow (X), eventual engagement between the first and second protrusions 562, 555, as best shown in FIG. 4, co-rotation of the first rotatable member 56, the manual operating member 41 (see FIG. 1), and the operating rod member 7 from the second angular position to the first angular position, and movement of the latching unit 6 from the unlatching position to the latching position, thereby disabling operation of the external handle unit 32.

It is noted that when the first rotatable member 56 is rotated to the first angular position, the second actuator 564 actuates the sensing element 571, as best shown in FIG. 5, to thereby deactivate the motor 81 of the electric driving unit 8. Due to the presence of inertial forces, the transmission shaft 811 (see FIG. 2) of the motor 81 continues to rotate momentarily, causing the second rotatable member 55 to further rotate and the second protrusion 555 to slide over the rounded portion 569 (see FIG. 2) of the first protrusion 562. As such, the second protrusion 555 is prevented from obstructing path of the first protrusion 562 during the operation of the electric door lock of this invention in the manual mode.

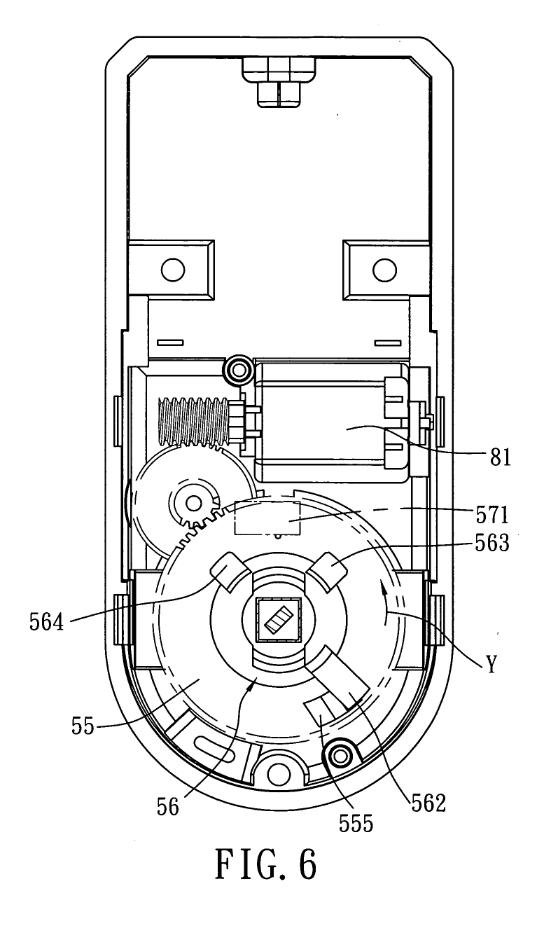

Thereafter, when it is desired to operate the electric door lock of this invention in the automated mode to enable operation of the external handle unit 32, referring to FIG. 5, the motor 81 of the electric driving unit 8 is activated with the use of the remote controller (not shown) or the keypad 851 of the user input unit (see FIG. 1). This results in rotation of the second rotatable member 55 in the first rotational direction, as indicated by the arrow (Y), eventual engagement between the first and second protrusions 562, 555, as best shown in FIG. 6, co-rotation of the first rotatable member 56, the manual operating member 41 (see FIG. 1), and the operating rod member 7 from the second angular position back to the first angular position, and movement of the latching unit 6 from the latching position back to the unlatching position, thereby enabling operation of the external handle unit 32.

It is noted that when the first rotatable member 56 is rotated back to the second angular position, the first actuator 563 actuates the sensing element 571, as best shown in FIG. 3, to thereby deactivate the motor 81 of the electric driving unit 8. Due to the presence of the aforementioned inertial forces, the transmission shaft 811 (see FIG. 2) of the motor 81 continues to rotate momentarily, causing the second rotatable member 55 to further rotate and the second protrusion 555 to slide over the rounded portion 569 (see FIG. 2) of the first protrusion 562. As such, the second protrusion 555 is prevented from obstructing the path of the first protrusion 562 during the operation of the electric door lock of this invention in the manual mode.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An electric door lock, comprising:
an internal lock housing formed with a handle mounting hole, and defining an accommodating space;
a latching unit movable between latching and unlatching positions;
a manual operating member mounted rotatably on said internal lock housing, extending into said accommodating space through said handle mounting hole, and coupled to said latching unit, said manual operating member being rotatable relative to said internal lock housing between a first angular position so as to dispose said latching unit at the latching position, and a second angular position so as to dispose said latching unit at the unlatching position;
a first rotatable member disposed in said accommodating space in said internal lock housing, including a ring portion sleeved securely on said manual operating member so as to be co-rotatable therewith between the first and second angular positions, and provided with a first protrusion that extends radially and outwardly from said ring portion of said first rotatable member;
a second rotatable member disposed in said accommodating space in said internal lock housing, mounted rotatably on said internal lock housing, disposed around said manual operating member, being in the form of a gear, and provided with a second protrusion that protrudes axially from said gear toward said first rotatable member, said second rotatable member being rotatable relative to said internal lock housing in a first rotational direction such that said second protrusion pushes said first protrusion so as to move said first rotatable member from the first angular position to the second angular position, and in a second rotational direction opposite to the first rotational direction such that said second protrusion pushes said first protrusion so as to move said first rotatable member from the second angular position back to the first angular position; and
an electric driving unit mounted in said accommodating space in said internal lock housing and operable so as to drive rotation of said second rotatable member.

2. (canceled)

3. The electric door lock as claimed in claim 1, wherein said ring portion of said first rotatable member is formed with a pair of diametrically disposed engaging recesses, said manual operating member having a pair of axially extending arms, each of which engages a respective one of said engaging recesses in said ring portion of said first rotatable member.

4. (canceled)

5. The electric door lock as claimed in claim 1, wherein said first protrusion is made from a resilient material and has a rounded portion.

6. (canceled)

7. The electric door lock as claimed in claim 1, further comprising:
an external lock housing; and
a lock member mounted on said external lock housing, extending into said external lock housing, and coupled to said latching unit, said lock member being operable so as to move said latching unit between the latching and unlatching positions.

8. The electric door lock as claimed in claim 7, further comprising an external handle unit mounted on said external lock housing, and operable so as to rotate relative to said external lock housing, said external handle unit being associated operably with said latching unit such that operation of said external handle unit is enabled when said latching unit is disposed at the unlatching position, and such that operation of said external handle unit is disabled when said latching unit is disposed at the latching position.

9. The electric door lock as claimed in claim 1, further comprising a switching unit for deactivating said electric driving unit when said first rotatable member has been moved from one of the first and second angular positions to the other of the first and second angular positions.

10. The electric door lock as claimed in claim 9, wherein said switching unit includes
a sensing element that is coupled electrically to said electric driving unit and that is operable so as to deactivate said electric driving unit when actuated,
a first actuator that is provided on said first rotatable member, and that actuates said sensing element when said first rotatable member is disposed at the second angular position, and
a second actuator that is provided on said first rotatable member, and that actuates said sensing element when said first rotatable member is disposed at the first angular position.
